(19) United States
(12) Patent Application Publication
(10) Pub. No.: US 2016/0226779 A1
(43) Pub. Date: Aug. 4, 2016

(54) DISTRIBUTION CONTROL METHOD, DISTRIBUTION CONTROL DEVICE, AND STORAGE MEDIUM

(71) Applicant: FUJITSU LIMITED, Kawasaki-shi (JP)

(72) Inventor: Shunsuke KIKUCHI, Shinagawa (JP)

(73) Assignee: FUJITSU LIMITED, Kawasaki-shi (JP)

(21) Appl. No.: 14/979,222

(22) Filed: Dec. 22, 2015

(30) Foreign Application Priority Data
Feb. 3, 2015 (JP) 2015-019598

(51) Int. Cl. H04L 12/855; H04L 12/26; H04L 12/841; H04L 12/813

(52) U.S. Cl. CPC H04L 47/2466; H04L 47/20; H04L 43/16; H04L 47/28

(57) ABSTRACT

A distribution control method executed by a computer configured to manage a plurality of nodes that controls communication between a plurality of communication devices and a plurality of information processing devices, each of the plurality of nodes having a filter rule indicating whether each of the information processing devices is permitted as a communication destination and collectively receiving, from the computer, all filter rules updated by the computer during a stopped state when the each of the plurality of nodes transits from the stopped state to an operating state, the method includes stopping at least one node among the plurality of nodes; operating at least one node among the plurality of nodes and is in the stopped state for a time period exceeding a predetermined threshold; and distributing the updated filter rules to the at least one operating node among the plurality of nodes, when the filter rules are updated.

### CROSS-REFERENCE TO RELATED APPLICATION

This application is based upon and claims the benefit of priority of the prior Japanese Patent Application No. 2015-019598, filed on Feb. 3, 2015, the entire contents of which are incorporated herein by reference.

### FIELD

The embodiment discussed herein is related to a distribution control method, a distribution control device, and a storage medium.

### BACKGROUND

A technique for executing filtering to control communication in order to ensure security when a terminal is connected to a network is known. As a related art, a technique for executing packet filtering by a firewall device in accordance with a predetermined filtering rule has been proposed (refer to Japanese Laid-open Patent Publication No. 2003-273936).

A technique for distributing a load of packet filtering to external filters installed at points connected to an external network and to internal filters installed between subnets and a backbone network connected to the external network has been proposed (refer to Japanese Laid-open Patent Publication No. 2003-244247).

A technique related to a communication system that includes a control device configured to set a packet processing rule in at least one of multiple nodes when receiving a request to set the processing rule is known (refer to Japanese National Publication of International Patent Application No. 2014-502796).

A filter rule (control information) that is used for the execution of filtering is managed by a managing device. Every time the filter rule is updated, the managing device distributes the filter rule to a device configured to execute the filtering.

When the number of devices configured to execute the filtering is increased, the managing device distributes the filter rule to the large number of devices. Thus, traffic in a network instantaneously increases. Hence, peak traffic of the network upon the distribution of the filter rule increases. It is desirable that peak traffic of the network upon the distribution of control information be reduced.

### SUMMARY

According to an aspect of the invention, a distribution control method executed by a computer configured to manage a plurality of nodes that controls communication between a plurality of communication devices and a plurality of information processing devices, each of the plurality of nodes having a filter rule indicating whether each of the information processing devices is permitted as a communication destination and collectively receiving, from the computer, all filter rules updated by the computer during a stopped state when the each of the plurality of nodes transits from the stopped state to an operating state, the distribution control method includes stopping at least one node among the plurality of nodes; operating at least one node among the plurality of nodes and is in the stopped state for a time period exceeding a predetermined threshold; and distributing the updated filter rules to the at least one operating node among the plurality of nodes, when the filter rules are updated.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a connection configuration of a network;

FIG. 2 is a functional block diagram illustrating an example of a communication terminal, a filter node, and a filter server;

FIG. 3 is a diagram illustrating an example of various tables of the filter node;

FIG. 4 is a diagram illustrating an example of various tables of the filter server;

FIG. 5 is a diagram illustrating an example of operational states of the filter node;

FIG. 6 is a diagram describing a first example of a reduction in peak traffic;

FIG. 7 is a diagram describing a second example of the reduction in the peak traffic;

FIG. 8 is a flowchart of an example of an operation of the filter server;

FIG. 9 is a sequence chart of an example of a process of acquiring a connection destination;

FIG. 10 is a sequence chart of another example of the process of acquiring a connection destination;

FIG. 11 is a first sequence chart of an example of a tunnel connection process;

FIG. 12 is a second sequence chart of the example of the tunnel connection process;

FIG. 13 is a sequence chart of an example of a process to be executed when a tunnel connection is disconnected;

FIG. 14 is a flowchart of an example of a process of stopping a filter node;

FIG. 15 is a flowchart of another example of the process of stopping a filter node;

FIG. 16 is a sequence chart of an example of a process of updating filter rules; and

FIG. 17 is a diagram illustrating an example of a hardware configuration of the filter server.

### DESCRIPTION OF EMBODIMENT

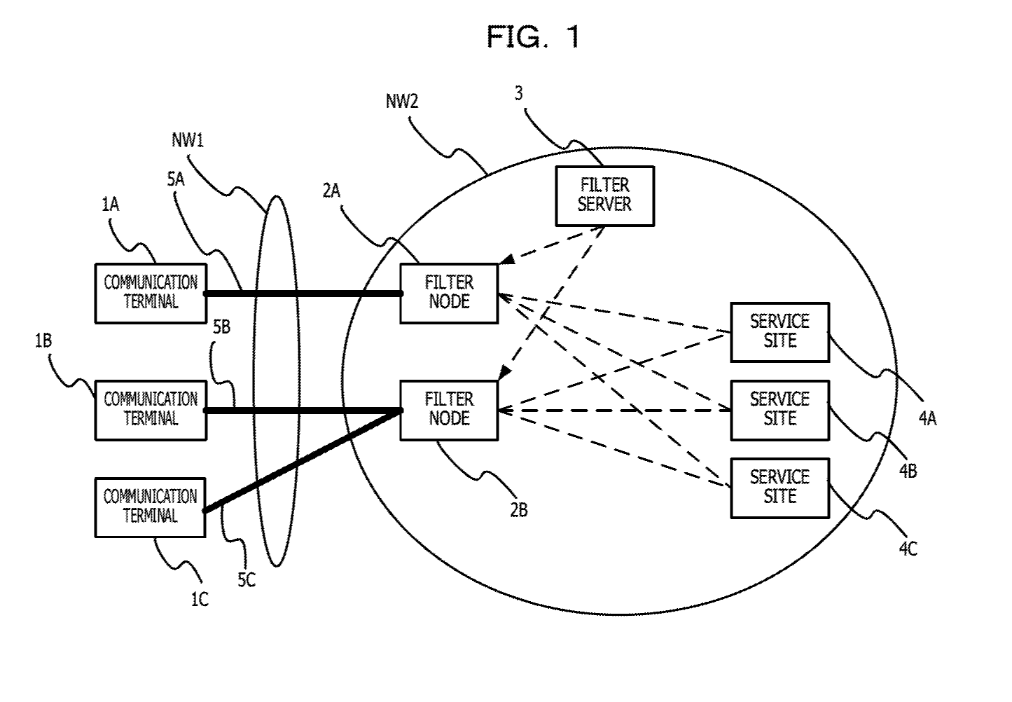

Hereinafter, an embodiment is described with reference to the accompanying drawings. FIG. 1 illustrates an example of a connection configuration of a network according to the embodiment. Communication terminals 1A, 1B, and 1C (hereinafter collectively referred to as communication terminals 1 in some cases) communicate with filter nodes 2A and 2B (hereinafter collectively referred to as filter nodes 2 in some cases) through a first network NW1.

A second network NW2 includes the filter nodes 2, a filter server 3, and service sites 4A, 4B, and 4C (hereinafter collectively referred to as service sites 4 in some cases). In the second network NW2, the filter nodes 2, the filter server 3, and the service sites 4 communicate with arbitrary communication destinations. In the example illustrated in FIG. 1, the communication executed in the second network NW2 is indicated by broken lines.

The first network NW1 includes tunnels 5A, 5B, and 5C (hereinafter collectively referred to as tunnels 5 in some cases). A single communication terminal 1 is connected to a single filter node 2 by a single tunnel 5. The number of communication terminals 1, the number of filter nodes 2, and the number of service sites 4 may be arbitrary. In the example illustrated in FIG. 1, the tunnels 5 are indicated by solid lines.

The communication terminals each have a communication function. The communication terminals 1 are smart devices such as mobile phones, tablet terminals, or smartphones, for example. In the embodiment, the communication terminals 1 are mobile terminals. The communication terminals 1, however, may be fixed terminals such as personal computers, for example.

The filter nodes 2 are devices configured to communicate with the communication terminals 1 through the tunnels 5. The filter nodes 2 receive communication requests from the communication terminals 1. The filter nodes 2 control communication from the communication terminals 1 based on filter rules. The filter nodes 2 are installed in a data center or the like, for example. The filter rules are an example of control information. The filter nodes 2 are an example of nodes.

In the embodiment, the filter rules are information indicating whether communication of communication destinations with the communication terminals 1 is permitted or prohibited. The filter rules may include other information. The filter nodes 2 limit the communication destinations of the communication terminals 1 based on the filter rules.

For example, the filter nodes 2 prohibit, based on a filter rule, communication of the communication terminals 1 with a service site 4 where information may leak or the like. Since the filter nodes 2 control communication from the communication terminals 1 (the control is hereinafter referred to as filtering in some cases), security is improved.

The filter server 3 is a computer configured to manage the filter nodes 2. The filter server 3 manages the filter rules. When a filter rule is updated, the filter server 3 distributes the updated filter rule to a filter node 2 that is operating.

The service sites 4 are the communication destinations of the communication terminals 1. If the filter nodes 2 permit the communication, the communication terminals 1 communicate with the service sites 4. Thus, the communication terminals 1 receive services provided by the service sites 4.

The second network NW2 is, for example, the Internet. The communication terminals 1 communicate with a service site 4 permitted by the filter nodes 2 among the service sites 4 on the Internet. The communication terminals 1 do not communicate with a service site 4 prohibited by the filter nodes 2 among the service sites 4 on the Internet. Thus, the security of the communication executed by the communication terminals 1 is ensured.

Each of the filter nodes 2 connected to the communication terminals 1 may dynamically change to any of the other filter nodes 2. For example, in the embodiment, the communication terminals 1 are the mobile terminals. In this case, each of the filter nodes 2 connected to the communication terminals 1 by the tunnels 5 may dynamically change to any of the other filter nodes 2 based on the positions of the communication terminals 1.

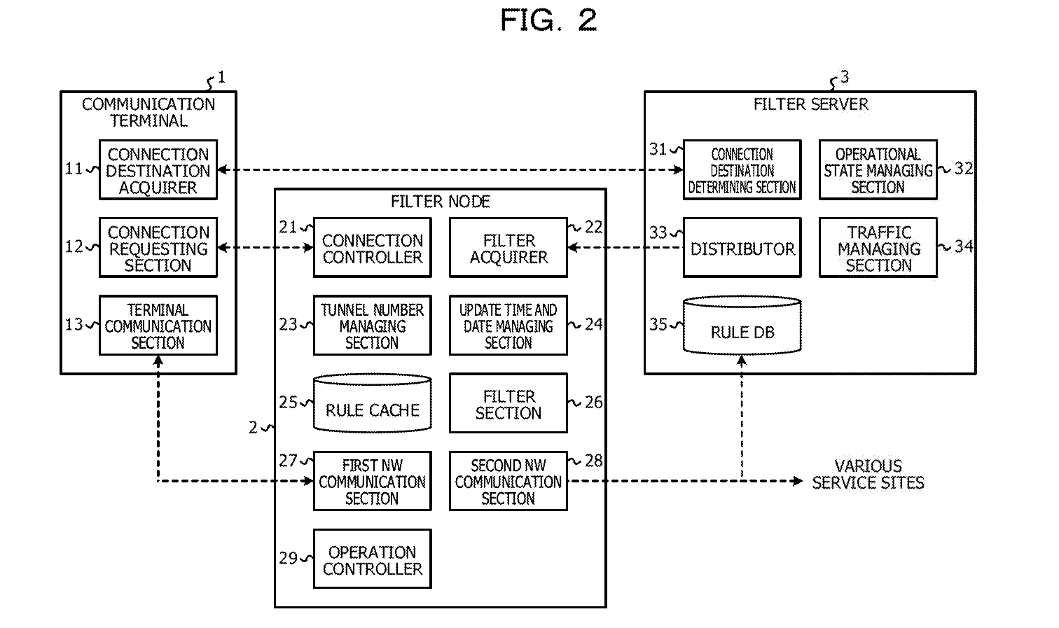

FIG. 2 illustrates an example of functional blocks of the communication terminals 1, functional blocks of the filter nodes 2, and functional blocks of the filter server 3. In FIG. 2, broken lines indicate communication between a communication terminal 1, a filter node 2, and the filter server 3.

The communication terminal 1 includes a connection destination acquirer 11, a communication requesting section 12, and a terminal communication section 13. If a tunnel 5 is not connected between the communication terminal 1 and the filter node 2, the connection destination acquirer 11 transmits, to the filter server 3, an inquiry about a filter node 2 that is a connection destination of the communication terminal 1. If the tunnel 5 is connected between the communication terminal 1 and the filter node 2, the communication terminal 1 communicates with the filter node 2 through the tunnel 5.

The filter server 3 determines the filter node 2 that is the connection destination of the communication terminal 1. Thus, the connection destination acquirer 11 transmits a request to acquire the connection destination so as to inquire about any of the multiple filter nodes 2 that is to be connected to the communication terminal 1.

Even if the communication terminal 1 executes communication, information does not leak or the like from the filter server 3, differently from the service sites 4 included in the second network NW2. Thus, the communication terminal 1 transmits the request to acquire the connection destination directly to the filter server 3.

The filter server 3 determines a filter node 2 to be assigned to the communication terminal 1 that transmitted the request to acquire the connection destination. The filter server 3 transmits, to the communication terminal 1 that transmitted the request to acquire the connection destination, a connection destination acquisition response to the request to acquire the connection destination that is the determined filter node 2. Thus, the connection destination acquirer 11 acquires information indicating any of the filter nodes 2 that is to be connected to the communication terminal 1.

The connection requesting section 12 transmits a tunnel connection request to the filter node 2 indicated by the connection destination acquisition response acquired by the connection destination acquirer 11. The filter node 2 connects a tunnel 5 between the communication terminal 1 and the filter node 2 in accordance with the tunnel connection request.

When the communication terminal 1 and the filter node 2 are connected to each other by the tunnel 5, the filter node 2 transmits a connection completion notification to the communication terminal 1. The communication terminal 1 receives the connection completion notification and thereby recognizes that the tunnel 5 was connected.

The terminal communication section 13 communicates with the service sites 4 through the filter node 2 after the tunnel 5 is connected. The terminal communication section 13 transmits, to the filter node 2, a communication request to communicate with a desired communication destination.

The communication request is a request to enable the communication terminal 1 to communicate with the network NW2. A precondition for the communication terminal 1 to communicate with the desired communication destination is that the connection of a tunnel 5 is established. Thus, the connection destination acquisition request and the tunnel connection request are a part of the communication request.

Next, the filter node 2 is described. The filter node 2 includes a connection controller 21, a filter acquirer 22, a tunnel number managing section 23, a update time and data managing section 24, a rule cache 25, a filter section 26, a first network communication section 27, a second network communication section 28, and an operation controller 29. In FIG. 2, networks are abbreviated to NW.

The connection controller 21 connects the communication terminal 1 and the filter node 2 to each other by the tunnel 5 in accordance with the tunnel connection request transmitted by the communication terminal 1. The connection controller 21 transmits a connection completion notification to the communication terminal 1 after the tunnel connection is completed.

The filter acquirer 22 acquires filter rules from the filter server 3. The tunnel number managing section 23 manages the number of tunnels 5 connected to the filter node 2. There is an upper limit (also referred to as capacity) on the number of tunnels 5 able to be connected to the filter node 2. If the number of tunnels 5 managed by the tunnel number managing section 23 reaches the upper limit, a communication terminal 1 is not assigned to the filter node 2 connected to the tunnels 5 whose number reached the upper limit.

The update date managing section 24 manages times and dates when the filter rules are updated. The rule cache 25 stores the filter rules acquired by the filter acquirer 22. When the filter acquirer 22 acquires a new filter rule, the rule cache 25 updates the stored filter rule.

The filter section 26 references the filter rules stored in the rule cache 25 and executes the filtering on the communication request received from the communication terminal 1. The first network communication section 27 communicates with the communication terminal 1 through the tunnel 5.

The second network communication section 28 communicates with an arbitrary communication destination within the second network NW2. For example, the second network communication section 28 communicates with the service sites 4. The second network communication section 28 transmits predetermined information to the filter server 3.

The filter section 26 controls communication based on the filter rules stored in the rule cache 25 in accordance with the communication request received by the first network communication section 27 from the communication terminal 1.

When the number of tunnels 5 managed by the tunnel number managing section 23 becomes equal to or larger than 1, the operation controller 29 causes the filter node 2 to operate. When the number of tunnels 5 managed by the tunnel number managing section 23 becomes 0, the operation controller 29 stops the filter node 2. Thus, when the number of tunnels 5 managed by the tunnel number managing section 23 becomes 0, the filter node 2 autonomously stops operating.

Next, the filter server 3 is described. The filter server 3 includes a connection destination determining section 31, an operational state managing section 32, a distributer 33, a traffic managing section 34, and a rule database 35. In FIG. 2, the rule database is abbreviated to a rule DB.

The connection destination determining section 31 determines, in accordance with a connection destination acquisition request transmitted by a communication terminal 1, a filter node 2 to be connected to the communication terminal 1. The connection destination determining section 31 does not assign a filter node 2, which is among the filter nodes 2 managed by the filter server 3 and is operating for a long time, to a connection destination indicated by the connection destination acquisition request.

The number of tunnels 5 connected to the filter node 2 that is not assigned to the connection destination of the communication terminal 1 is reduced over time. Then, when the number of tunnels 5 connected to the filter node 2 becomes 0, the filter node 2 is stopped.

The connection destination determining section 31 assigns a filter node 2 that is among the filter nodes 2 managed by the filter server 3 and is stopped for a long time to the connection destination indicated by the connection destination acquisition request. Thus, the filter node 2 that is stopped for the long time operates. Thus, the connection destination determining section 31 functions as a controller that controls the filter nodes 2 so as to stop a filter node 2 operating for a long time and cause a filter node 2 stopped for a long time to operate.

The operational state managing section 32 manages operational states of the filter nodes 2 managed by the filter server 3. The operational states include the latest times and dates when the filter nodes 2 are updated, times and dates when the filter nodes 2 start operating, operational states of the filter nodes 2, the numbers of tunnels that are available until the numbers of tunnels connected to the filter nodes 2 reach the upper limit, and the amounts of accumulated data of the filter rules updated during the times when the filter nodes 2 are stopped.

When filter rules stored in the rule database 35 are updated, the distributor 33 distributes the updated filter rules to a filter node 2 that is operating. The traffic managing section 34 manages steady traffic.

The steady traffic is traffic that serves as an index to be used in order for the filter server 3 to stably distribute the filter rules to the filter nodes 2. The steady traffic may be arbitrarily set. The steady traffic is an example of a predetermined data amount.

The rule database 35 stores the filter rules. The filter rules are updated at certain times. When the filter rules are updated, the filter rules stored in the rule database 35 are updated.

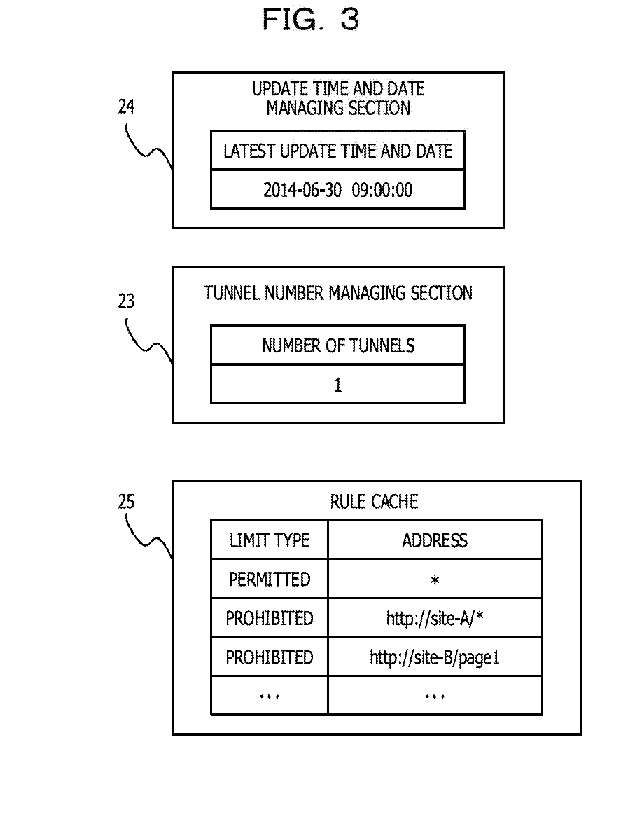

FIG. 3 illustrates an example of a table indicating the latest update time and date and managed by the update time and date managing section 24, an example of a table indicating the number of tunnels that is managed by the tunnel number managing section 23, and an example of a table indicating the filter rules stored in the rule cache 25.

The latest time and date is the latest time and date when the filter rules stored in the rule cache 25 are updated. The number of tunnels is the number of tunnels 5 to which the filter node 2 is currently connected.

The rule cache 25 stores limit types and addresses for the filter rules. The example illustrated in FIG. 3 indicates three filter rules. The number of filter rules, however, is not limited to 3. The addresses indicate addresses of communication destinations. The limit types indicate whether communication from a communication terminal 1 to the addresses is permitted or prohibited.

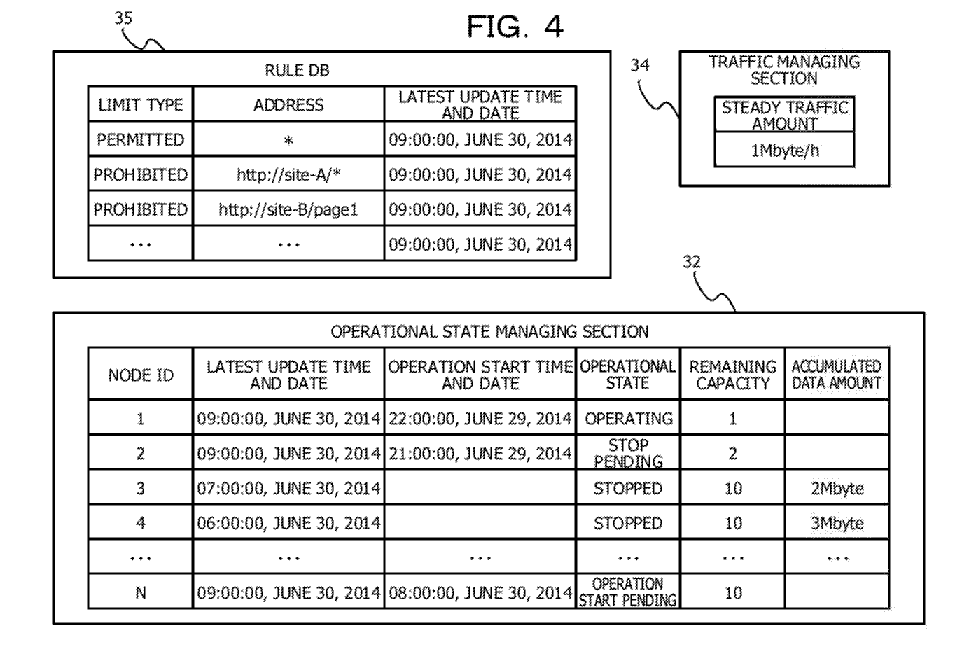

FIG. 4 illustrates an example of a table indicating the filter rules stored in the rule database 35, an example of a table indicating the steady traffic managed by the traffic managing section 34, an example of an operational state management table managed by the operational state managing section 32.

The rule database 35 stores the limit types, the addresses, and the latest update times and dates for the filter rules. The limit types and the addresses are the same as the aforementioned limit types and the aforementioned addresses. The latest update times and dates are the latest times and dates when the filter rules are updated.

The traffic managing section 34 manages the steady traffic. In the example illustrated in FIG. 4, the steady traffic managed by the traffic managing section 34 indicates a data amount of 1 Mbyte per hour. Thus, if the amount of data of filter rules distributed by the filter server 3 to a filter node 2 is smaller than 1 Mbyte, the filter server 3 stably distributes the filter rules.

The operational state management table managed by the operational state managing section 32 includes items for node IDs, the latest update times and dates, operation start times and dates, operational states, remaining capacities, and accumulated data amounts. The IDs stand for identifications.

The node IDs are identifiers identifying filter nodes 2. In the example illustrated in FIG. 4, the number of the filter nodes 2 managed by the filter server 3 is N (N is a natural number). The latest update times and dates are the latest times and dates when the filter rules stored in the rule caches 25 are updated for the filter nodes 2.

The operation start times and dates are the times and dates when the filter nodes 2 start operating. For example, when the filter nodes 2 notify the filter server 3 that the filter nodes 2 started operating, the operational state managing section 32 recognizes the times and dates when the filter nodes started operating.

The operational states indicate operational states of the filter nodes 2. When the filter nodes 2 notify the filter server 3 of the operational states of the filter nodes 2, the operational state managing section 32 recognizes the operational states of the filter nodes 2.

The remaining capacities indicate the numbers of available tunnels 5 able to be connected to the filter nodes 2. The remaining capacities are values obtained by subtracting the numbers of tunnels 5 currently connected to the filter nodes 2 from the aforementioned capacity.

The connection destination determining section 31 assigns filter nodes 2 or connection destinations to the communication terminals 1. Thus, the operational state managing section 32 may recognize the remaining capacities based on the numbers of tunnels 5 assigned to the filter nodes 2 by the connection destination determining section 31.

The filter nodes 2 may notify the filter server 3 of the numbers of tunnels 5 that are managed by the tunnel number managing sections 23 of the filter nodes 2. Thus, the operational state managing section 32 may recognize the remaining capacities based on the notifications.

In the embodiment, the upper limit (capacity) on the numbers of tunnels 5 able to be connected to the filter nodes 2 is 10. The numbers of tunnels 5 able to be connected to the filter nodes 2, however, may be different from each other.

In the example illustrated in FIG. 4, a remaining capacity of a filter node 2 with a node ID 1 is 1. Thus, the filter node 2 with the node ID 1 is currently connected to nine tunnels 5.

The accumulated data amounts indicate the amounts of accumulated data of filter rules that are updated during the stop of filter nodes and are to be provided to the filter nodes whose operational states indicate stopped. Thus, the longer a time period for which a filter node 2 whose operational state indicates stopped is stopped, the larger an accumulated data amount of the filter node 2.

When a filter node 2 starts operating, filter rules updated during the stop of the filter node 2 are collectively distributed by the filter server 3 to the filter node 2. Thus, when a certain filter node 2 transitions from a stopped state to an operating state, updated filter rules are collectively distributed by the filter server 3 to the certain filter node 2 and thus peak traffic instantaneously increases. The larger an accumulated data amount (or the longer a time period for which the filter node 2 is stopped), the larger the peak traffic.

In the example illustrated in FIG. 4, a filter node 2 with a node ID 3 is stopped for a time period of 2 hours and does not receive filter rules of which an accumulated data amount is 2 Mbytes. A filter node 2 with a node ID 4 is stopped for a time period of 3 hours and does not receive filter rules of which an accumulated data amount is 3 Mbytes.

Thus, peak traffic when each of the filter node 2 with the node ID 3 and the filter node 2 with the node ID 4 collectively receives filter rules that are not received during the stop of the filter nodes 2 exceeds the steady traffic.

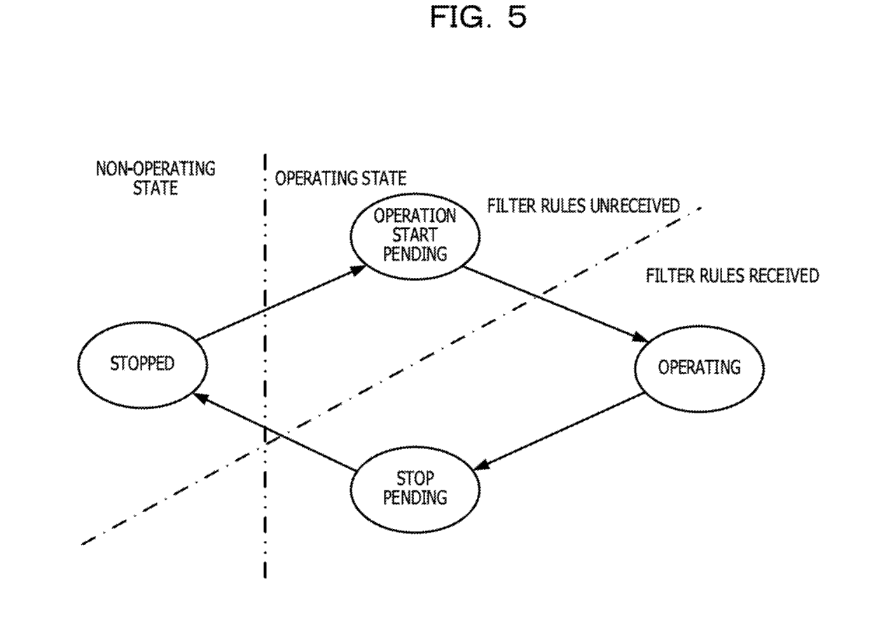

Next, an example of operational states of the filter nodes 2 is described with reference to FIG. 5. In the example, operational states of each of the filter nodes 2 are four states, operating, stop pending, stopped, and operation start pending.

Operating indicates the state of a filter node 2 that is operating. When the filter rules are updated, the filter server 3 distributes the filter rules to a filter node 2 whose operational state indicates operating. Stop pending indicates the state of a filter node 2 that is transitioning from the operating state. When a filter node 2 becomes the stop pending state, the filter node 2 is still operating. Thus, the filter server 3 distributes the updated filter rules to the filter node 2 whose operational state indicates stop pending.

The connection destination determining section 31 of the filter server 3, however, does not assign a connection destination to the filter node 2 whose operational state indicates stop pending. Thus, the number of tunnels connected to the filter node 2 whose operational state indicates stop pending is reduced over time and finally becomes 0.

When the number of tunnels connected to the filter node 2 becomes 0, the operational state of the filter node 2 changes to the stopped state. The filter node 2 whose operational state indicates stopped does not communicate with the filter server 3. Thus, stop pending is a transitional state in which the filter node 2 transitions from the operating state to the stopped state. Stop pending is an example of a first transitional state.

When the filter server 3 assigns a communication request to a filter node 2 whose operational state indicates stopped, the filter node 2 transitions from the stopped state to the operation start pending state. The number of tunnels 5 connected to the filter node 2 whose operational state indicates operation start pending is 0, and the filter node 2 whose operational state indicates operation start pending had not received a filter rule from the distributor 33 of the filter server 3. Thus, the filter node 2 whose operational state indicates operation start pending receives, from the filter server 3, a filter rule that was not received during the stop of the filter node 2.

When the filter node 2 whose operational state indicates operation start pending is connected to a tunnel 5 and receives the filter rule distributed by the distributor 33, the filter node 2 transitions from the operation start pending state to the operating state. Thus, operation start pending is a transitional state in which the filter node 2 transitions from the stopped state to the operating state. Operation start pending is an example of a second transitional state.

Thus, the filter node 2 transitions to the four states. As illustrated in FIG. 5, filter nodes whose operational states are the operating state and the stop pending state receive filter rules. Filter nodes 2 whose operational states are the stopped state and the operation start pending state do not receive a filter rule.

A chain line illustrated in FIG. 5 indicates a boundary between the states in which the filter rules are received and the states in which the filter rules are not received. In addition, a chain double-dashed line illustrated in FIG. 5 indicates a boundary between the states in which the filter nodes 2 are operating and the state in which the filter nodes 2 are not operating.

In the embodiment, even if a filter node 2 is in the stopped state, the filter node 2 maintains a state in which the filter node 2 recognizes a communication request from a communication terminal 1. The filter node 2 in the stopped state does not receive a filter rule. Thus, in the second network NW2, filter nodes 2 that are in the stopped states do not execute communication.

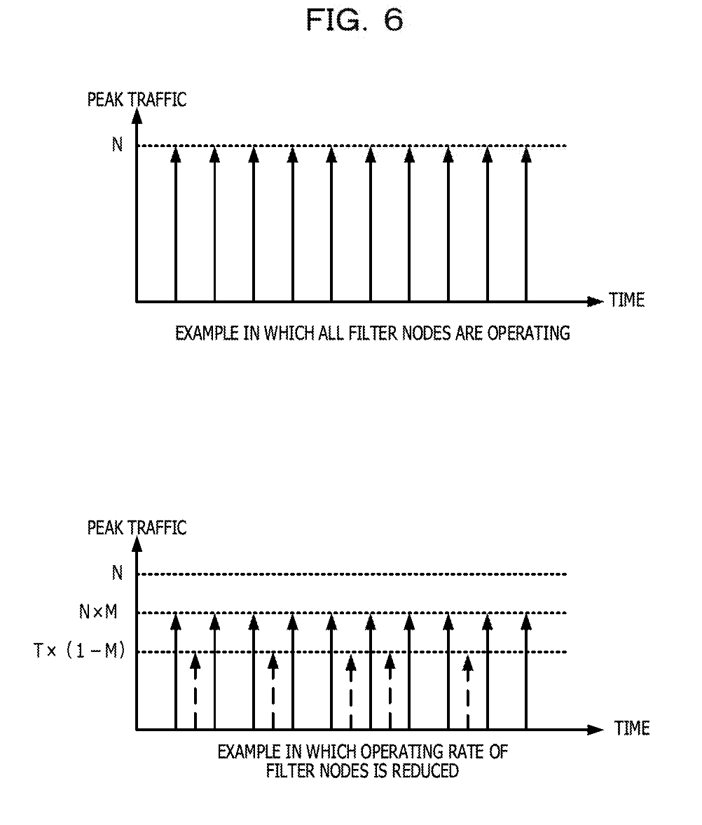

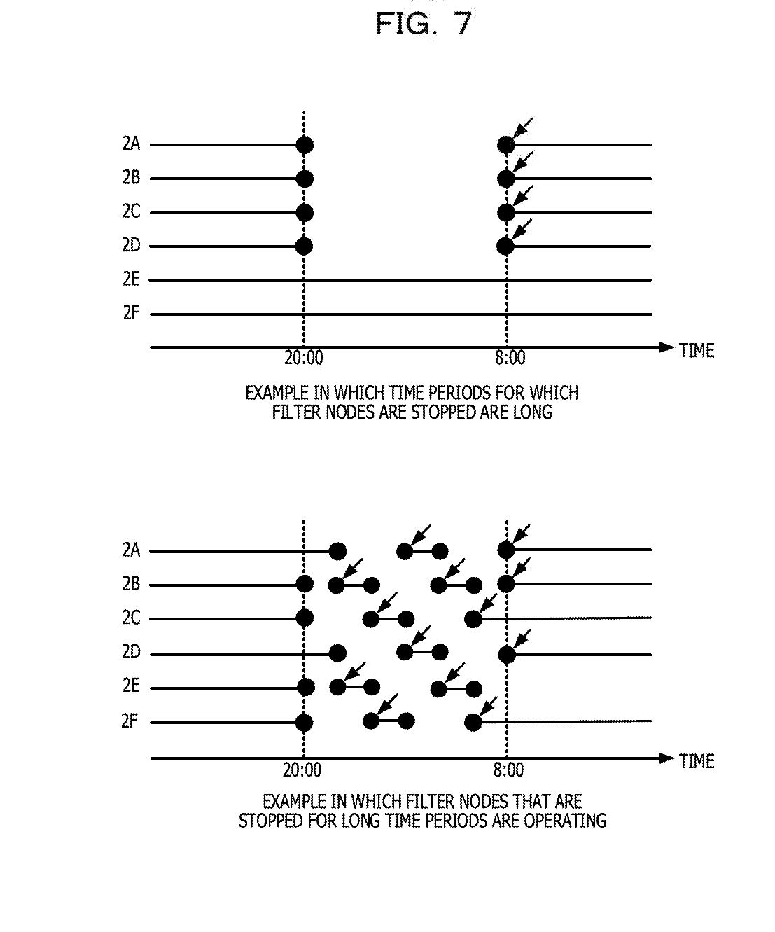

Next, examples of a reduction in peak traffic are described with reference to FIGS. 6 and 7. An example that is illustrated in FIG. 6 and in which “all the filter nodes are operating” indicates an example of peak traffic when the operational states of all the filter nodes 2 managed by the filter server 3 are the operating states.

The number of the filter nodes 2 managed by the filter server 3 is N. The filter rules stored in the rule database 35 of the filter server 3 are updated every 1 minute. The amount of data of the filter rules distributed by the filter server 3 to the filter nodes 2 in the operating states upon the update is 1.

Thus, peak traffic when the filter server 3 distributes the filter rules to the filter nodes 2 is N (=N×1). Since the filter rules are updated every 1 minute, the peak traffic becomes N every 1 minute.

An “example in which an operating rate of the filter nodes is reduced” indicates an example of peak traffic when the number of filter nodes 2 that are among the filter nodes managed by the filter server 3 and receive the filter rules is reduced.

The operating rate M (0<M≦1) is the ratio of the number of filter nodes 2 that are among all the filter nodes 2 managed by the filter server 3 and receive the filter rules to the number of all the filter nodes 2 managed by the filter server 3. In this case, the filter server 3 distributes the filter rules to a number (M×N) of filter nodes 2. Thus, the peak traffic is N×M.

Thus, the peak traffic upon the distribution of the filter rules when the operating rate M of the filter nodes 2 is reduced is lower than the peak traffic upon the distribution of the filter rules when all the filter nodes 2 are operating. In order to reduce the operating rate of the filter nodes 2, the filter server 3 controls the filter nodes 2 so as to stop operating filter nodes 2 among the filter nodes 2 managed by the filter server 3.

When a certain filter node 2 transitions from the stopped state to the operation start pending state and transitions from the operation start pending state to the operating state, the filter server 3 collectively distributes, to the certain filter node 2, all filter rules that were not received by the filter node 2 during the stop of the certain filter node 2.

Thus, if a time period for which the certain filter node is in the stopped state is T (T is a natural number) minutes, peak traffic when the filter server 3 collectively distributes the filter rules to the certain filter node 2 is T×(1−M).

For example, if the time period for which the certain filter node is in the stopped state is 2 hours or “2×60” minutes, peak traffic when the filter server 3 collectively distributes the filter rules to the certain filter node 2 is “2×60×(1−M)”.

For example, if the operating state M is 0.8, peak traffic upon the distribution of the filter rules is 24 according to the aforementioned equation.

The number of the filter nodes 2 managed by the filter server 3 is large. For example, it is assumed that the number N of all the filter nodes 2 is 70.

In this case, when the filter server 3 distributes the filter rules to all the filter nodes 2, the peak traffic upon the distribution of the filter rules is 70. Thus, the peak traffic is reduced from 70 to 56 by the reduction in the operating rate of the filter nodes 2.

When filter nodes 2 that had been in the stopped state transition from the stopped states through the operation start pending states to the operating states, peak traffic occurs due to the collective distribution of filter rules. The peak traffic occurs randomly over time upon the transition of the states of the multiple filter nodes 2. This is due to the fact that all the filter nodes 2 in the stopped states do not simultaneously start operating.

The peak traffic upon the distribution of the filter rules is reduced by the reduction in the operating rate of the filter nodes 2. When the operating rate of the filter nodes 2 is reduced, the number of filter nodes 2 in the stopped states increases.

In this case, when time periods for which the filter nodes 2 are in the stopped states increase, the amounts (accumulated data amounts) of data of filter rules to be collectively received by the filter nodes 2 upon the transition of the filter nodes 2 to the operating states increase. Thus, the peak traffic upon the distribution of the filter rules increases.

The peak traffic may exceed N depending on the amount of data of filter rules to be distributed. In this case, the peak traffic is larger than peak traffic when all the filter nodes 2 are operating.

Thus, the filter server 3 causes a filter node 2 to operate, while the filter node 2 is among filter nodes 2 in the stopped states and is in the stopped state for a long time. Thus, the filter server 3 controls the amount of data of filter rules to be distributed or reduces the amount of the data of the filter rules to be received by the filter node 2 when the filter node 2 in the stopped state transitions to the operating state.

In an “example in which filter nodes 2 are in the stopped states for a long time” and that is illustrated in FIG. 7, the filter nodes 2A to 2D that are among the filter nodes 2A to 2F transition to the stopped states at 20 o'clock. Then, the filter nodes 2A to 2D transition to the operating states at 8 o'clock.

The filter nodes 2E and 2F operate during a time period from 20 o'clock to 8 o'clock. Thus, the operating rate M of the filter nodes 2 during the time period from 20 o'clock to 8 o'clock is “M=2/6=1/3”. In this case, since the operating rate is reduced, peak traffic is considered to be reduced.

The filter nodes 2A to 2D do not receive the filter rules for the time period of 12 hours. At 8 o'clock, the filter nodes 2A to 2D collectively receive the filter rules for the time period of 12 hours for which the filter nodes 2A to 2D were in the stopped states. Thus, peak traffic upon the distribution of the filter rules increases.

In an “example in which the filter nodes that are in the stopped states for a long time are operating”, the filter server 3 controls the filter nodes 2 so as to cause the filter nodes 2 that had been in the stopped states for the long time to transition to the operating states. Thus, filter nodes 2 that are among the filter nodes 2A to 2F and are in the operating states are chronologically distributed.

In the example illustrated in FIG. 7, the filter server 3 controls the filter nodes 2 so as to cause filter nodes 2 that are among the filter nodes 2A to 2F and are each stopped for a time period of 4 hours or less to transition to the operating states. In FIG. 7, arrows indicate that the filter nodes 2 collectively receive the filter rules.

At 22 o'clock, a filter node 2 that is in the stopped state for 4 hours does not exist. Thus, the filter server 3 controls the filter nodes 2 so as to cause filter nodes 2 that are among the filter nodes 2A to 2F and are stopped for a time period of 2 hours to transition to the operating states. The filter server 3 controls the filter nodes 2 so that the filter nodes 2 are in the stopped states for time periods of 4 hours or less. The filter server 3 controls the filter nodes 2 so that if a filter node 2 is stopped for a time period of 4 hours, the filter node 2 transitions to the operating state.

In the “example in which the filter nodes 2 are in the stopped states for the long time”, the operating rate M of the filter nodes 2 during the time period from 20 o'clock to 8 o'clock is “⅓”. In the “example in which the filter nodes that are in the stopped states for the long time are operating”, the operating rate M of the filter nodes 2 during the time period from 20 o'clock to 8 o'clock is also “⅓”. Thus, since the operating rate M is reduced, peak traffic upon the distribution of the filter rules is reduced.

The peak traffic upon the distribution of the filter rules is the amount of data of the filter rules for a time period of up to 4 hours. Thus, the peak traffic upon the distribution of the filter rules is reduced, compared with the amount of data of the filter rules for 12 hours that are collectively distributed by the filter server 3.

Since the filter server 3 not only reduces the operating rate M of the filter nodes 2 but also controls the filter nodes 2 so as to cause a filter node 2 stopped for a long time to operate, the filter server 3 adjusts the number of filter nodes 2 that are destinations of the filter rules to be distributed. Thus, the peak traffic upon the distribution of the filter rules is reduced.

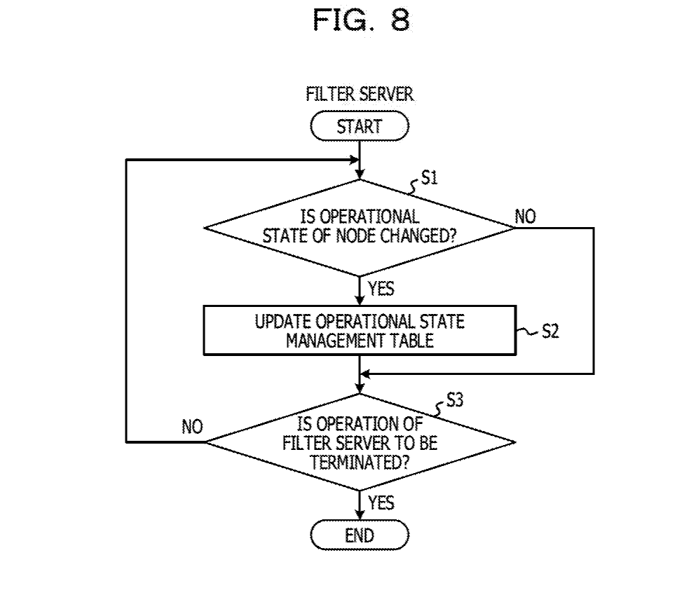

Next, an example of an operation of the filter server 3 is described with reference to a flowchart illustrated in FIG. 8. The filter server 3 determines whether or not the operational state of at least any of the filter nodes 2 was changed (in S1). In flowcharts and sequence charts illustrated in FIG. 8 and later, the filter nodes are expressed as nodes.

For example, when receiving, from a filter node 2, a notification indicating that the operational state of the filter node 2 was changed, the filter server 3 recognizes that the operational state of the filter node 2 was changed. When the connection destination determining section 31 does not assign a communication request to an operating filter node 2, the filter server 3 recognizes that the filter node 2 transitioned from the operating state to the stop pending state. When the connection destination determining section 31 assigns a communication request to a filter node 2 that is in the stopped state, the filter server 3 recognizes that the operational state of the filter node 2 was changed.

If the operational state of at least any of the filter nodes 2 was changed (Yes in S1), the operational state managing section 32 updates the operational state management table (in S2). Thus, the operational state managing section 32 manages the operational states of the filter nodes 2.

If the operational states of the filter nodes 2 are not updated (No in S1), the operational state managing section 32 does not update the operational state management table. Next, the filter server 3 determines whether or not the filter server 3 terminates the operation of the filter server 3 (in S3). If the filter server 3 does not terminate the operation of the filter server 3 (No in S3), a process returns to S1. If the server 3 terminates the operation of the filter server 3 (Yes in S3), the process is terminated.

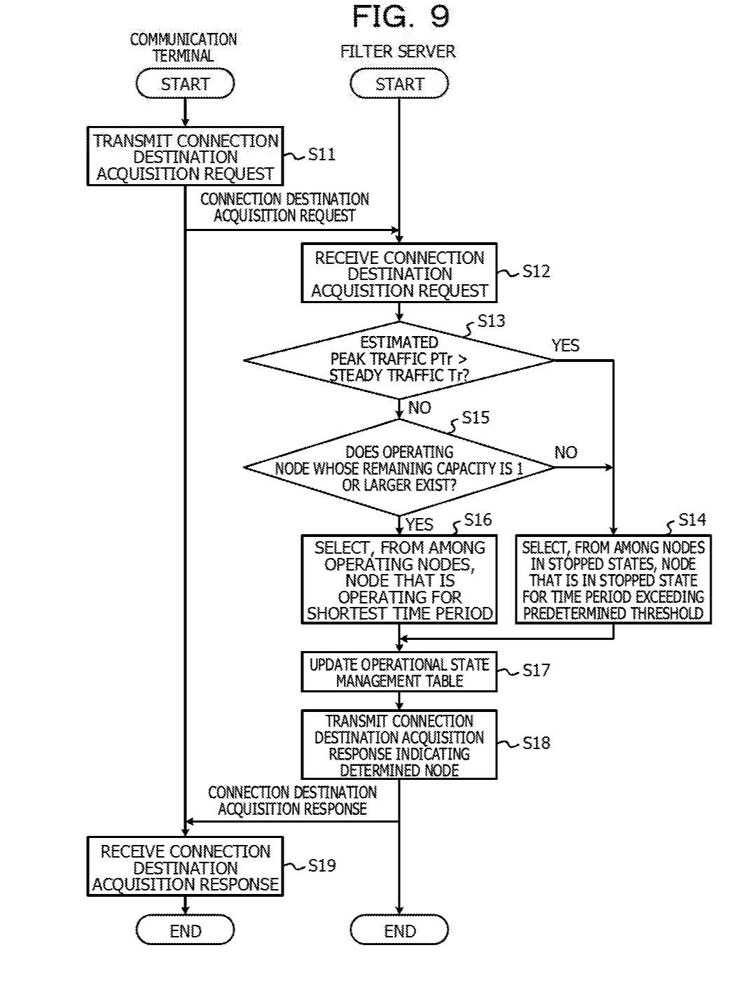

An example of a process of acquiring a connection destination is described with reference to a sequence chart illustrated in FIG. 9. As described above, a connection destination acquirer 11 of a communication terminal 1 transmits, to the filter server 3, a request to acquire a connection destination as a communication request (in S11). In this case, the communication terminal 1 is yet to be connected to any of the filter nodes 2 through a tunnel 5.

The connection destination determining section 31 of the filter server 3 receives the communication request (in S12). The connection destination determining section 31 references the operational state managing section 32 and the traffic managing section 34 and determines whether or not estimated peak traffic exceeds the steady traffic (in S13). In FIG. 9, the estimated peak traffic is expressed as estimated peak traffic Ptr, and the steady traffic is expressed as steady traffic Tr.

The estimated peak traffic is peak traffic estimated to occur upon the distribution of the filter rules. In the embodiment, the estimated peak traffic is an accumulated data amount stored in the operational state management table managed by the operational state managing section 32. The estimated peak traffic may be calculated using another method.

If a filter node 2 that causes the estimated peak traffic to exceed the steady traffic exists (Yes in S13), the connection destination determining section 31 selects, from among filter nodes 2 in the stopped states, a filter node 2 that is in the stopped state for a time period exceeding a predetermined threshold (in S14).

If the estimated peak traffic exceeds the steady traffic, peak traffic upon the distribution of the filter rules is larger than the steady traffic. The longer a time period for which a filter node 2 is stopped, the larger the amount of accumulated data of the filter rules to be collectively distributed by the filter server 3 to the filter node 2.

Thus, the connection destination determining section 31 controls a filter node 2 in the stopped state for a long time and thereby causes the filter node 2 to operate. Since the filter server 3 causes a filter node 2 stopped for a long time to operate on a priority basis, the amount of data of the filter rules to be collectively distributed by the filter server 3 to filter nodes 2 is reduced. Thus, peak traffic upon the distribution of the filter rules is reduced.

The connection destination determining section 31 determines whether or not time periods for which the filter nodes 2 are in the stopped states are long by determining whether or not the time periods exceed a predetermined threshold. The predetermined threshold may be set to an arbitrary value. If multiple filter nodes 2 that are in the stopped states for time periods exceeding the predetermined threshold exist, the connection destination determining section 31 selects an arbitrary one filter node 2 from among the multiple filter nodes 2.

If the estimated peak traffic does not exceed the steady traffic (No in S13), the connection destination determining section 31 determines whether or not at least one filter node 2 that is operating and whose remaining capacity is 1 or larger exists (in S15).

If the filter node 2 that is operating and whose remaining capacity is 1 or larger does not exist (No in S15), the connection destination determining section 31 does not assign a filter node 2 to the communication terminal 1 that transmitted the request to acquire the connection destination. In this case, the connection destination determining section 31 controls a filter node 2 in the stopped state so as to causes the filter node 2 to operate and assigns the filter node 2 to the connection destination.

In this case, in order to reduce peak traffic upon the distribution of the filter rules, the connection destination determining section 31 selects, from among filter nodes in the stopped states, a filter node 2 that is in the stopped state for a time period exceeding the predetermined threshold and is to be assigned to the connection destination of the communication terminal 1 (in S14).

If the filter node 2 that is operating and whose remaining capacity is 1 or larger exists (Yes in S15), the connection destination determining section 31 selects, from among operating filter nodes 2, a filter node 2 that is operating for the shortest time period (in S16).

Thus, since a connection from a communication terminal 1 is not assigned to a filter node 2 that is operating for a long time, a remaining capacity of the filter node 2 that is operating for the long time is reduced. Then, the filter node 2 that is operating for the long time quickly transitions to the stopped state. Thus, peak traffic is reduced.

In S16, the connection destination determining section 31 selects the filter node 2 to be assigned to the communication terminal 1 that transmitted the request to acquire the connection destination. The operational state managing section 32 updates information of the selected filter node 2 in the operational state management table (in S17).

The connection destination determining section 31 determines the selected filter node 2 as the connection destination to be assigned to the communication terminal 1. Then, the connection destination determining section 31 transmits, as a response to the request to acquire the connection destination, a connection destination acquisition response indicating the determined filter node 2 to the communication terminal 1 that transmitted the request to acquire the connection destination (in S18).

The communication terminal 1 receives the connection destination acquisition response transmitted by the connection destination determining section 31 of the filter server 3 (in S19). Thus, the communication terminal 1 recognizes whether or not the communication terminal 1 is connected to any of the filter nodes 2.

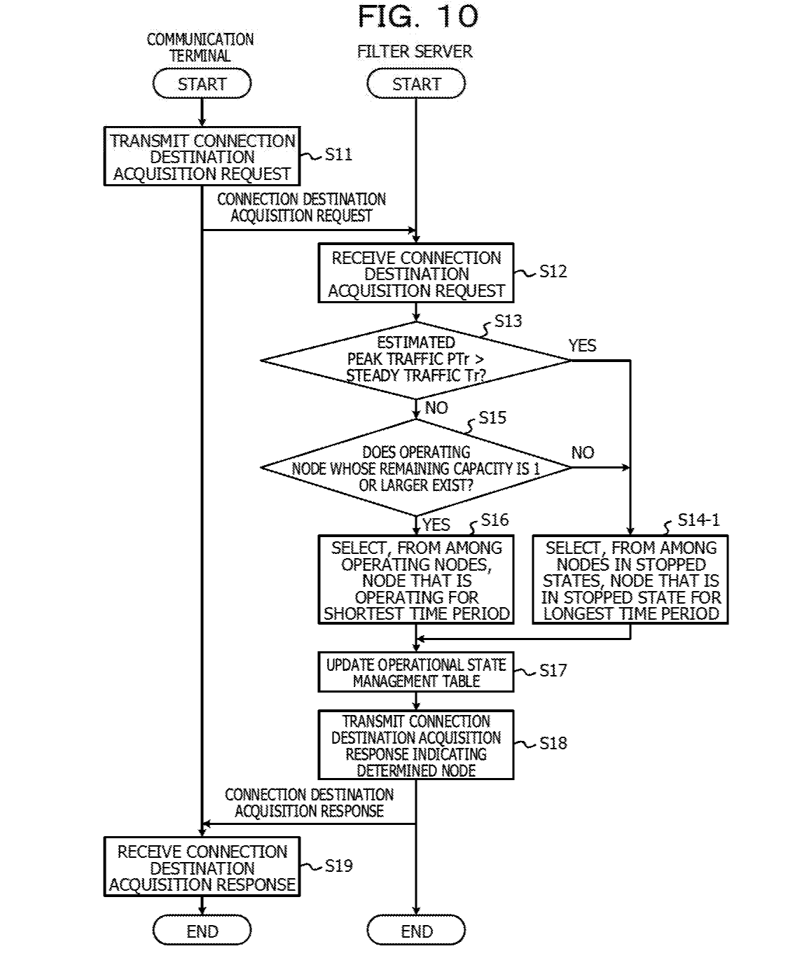

FIG. 10 illustrates another example of the process of acquiring a connection destination. The process of acquiring a connection destination in the example illustrated in FIG. 10 is different in S14 from the process described above in the example illustrated in FIG. 9. In the process of acquiring a connection destination in the example illustrated in FIG. 10, a filter node 2 that is in the stopped state for the longest time period is selected from among the filter nodes 2 that are in the stopped states (in S14-1).

If multiple filter nodes 2 that are in the stopped states for long time periods exist, an accumulated data amount of the filter node 2 that is stopped for the longest time period is the largest. Thus, the filter server 3 controls the filter node 2 so as to cause the filter node 2 in the stopped state for the longest time period to operate on a priority basis. Thus, an effect of reducing peak traffic upon the distribution of the filter rules is the highest.

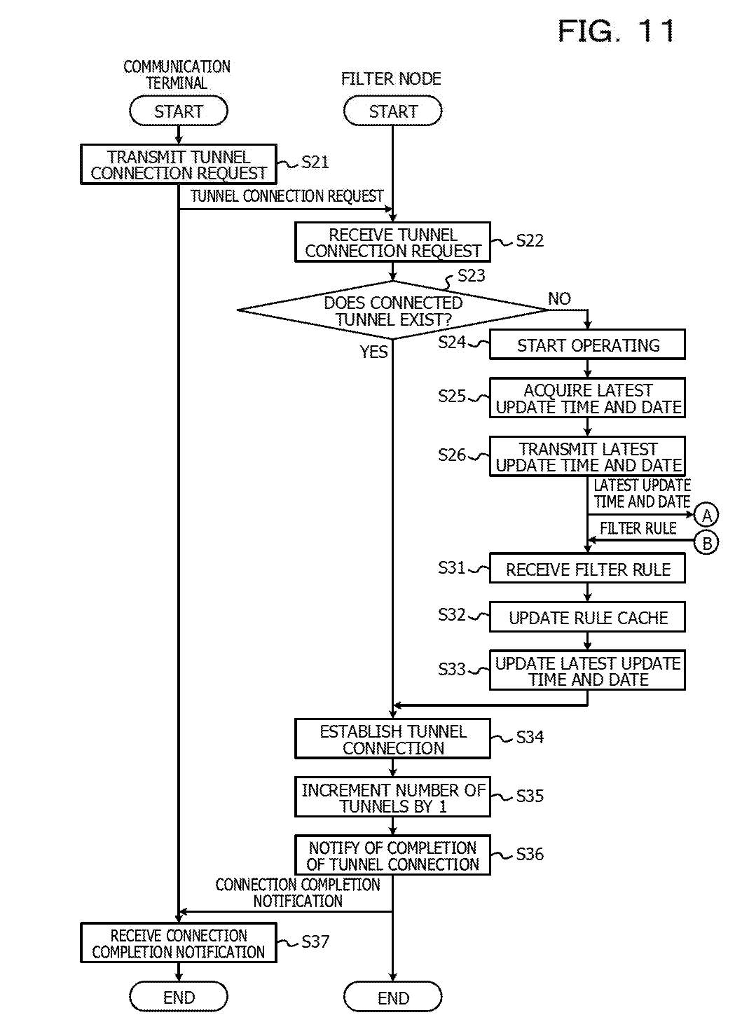

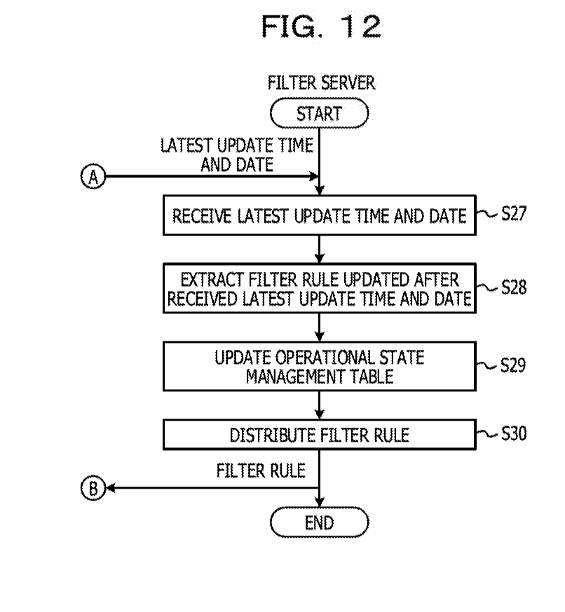

Next, an example of a tunnel connection process is described with reference to sequence charts illustrated in FIGS. 11 and 12. The communication terminal 1 recognizes the filter node 2 that is the connection destination based on the connection destination acquisition response.

The communication terminal 1 transmits a tunnel connection request to the filter node 2 recognized in accordance with the procedure described with reference to FIGS. 9 and 10 (in S21). The connection controller 21 of the filter node 2 receives the tunnel connection request (in S22).

The filter node 2 determines, based on the number of tunnels 5 managed by the tunnel number managing section 23, whether or not a tunnel 5 already connected to the filter node 2 exists (in S23). If the tunnel 5 already connected to the filter node 2 does not exist (No in S23), the operation controller 29 controls the filter node 2 so as to cause the filter node 2 to start operating (in S24). Thus, the filter node 2 transitions from the stopped state to the operation start pending state.

The second network communication section 28 acquires the latest update time and date managed by the update time and date managing section 24 (in S25). The second network communication section 28 transmits information of the acquired latest update time and date to the filter server 3 (in S26). Then, the process proceeds to “A”.

FIG. 12 illustrates the flow of a process to be executed by the filter server 3 after “A”. The filter server 3 receives the information of the latest update time and date (in S27). The distributor 33 of the filter server 3 extracts at least one filter rule updated after the received latest time and date from the rule database 35. Specifically, the filter rule that is yet to be distributed to the filter node 2 is extracted (in S28).

The operational state managing section 32 updates information, stored in the operational state management table, of the filter node 2 that transmitted the information of the latest update time and date (in S29). Thus, the filter server 3 recognizes the latest update time and date of the filter rule for the filter node 2 by updating the operational state management table.

The distributor 33 distributes the extracted at least one filter rule to the filter node 2 that transmitted the information of the latest update time and date (in S30). Then, the process proceeds to “B”. Next, processes to be executed after “B” are described with reference to FIG. 11.

The filter acquirer 22 receives the at least one filter rule from the distributor 33 (in S31). The filter node 2 updates the rule cache 25 so as to reflect the received filter rule in the rule cache 25 (in S32). The update time and date managing section 24 updates the current update time and date to the received latest update time and date of the filter rule (in S33).

Then, the filter node 2 establishes the connection of a tunnel 5 between the filter node 2 and the communication terminal 1 that transmitted the communication request (in S34). Even if the filter node 2 determines that the tunnel 5 already connected to the filter node 2 exists in S23, the process of S34 is executed.

Since the new connection of the tunnel 5 is newly established, the tunnel number managing section 23 increments the number of managed tunnels 5 by 1 (in S35). Then, the filter node 2 transmits, to the communication terminal 1, a tunnel connection completion notification indicating that the tunnel connection was completed (in S36).

The communication terminal 1 receives the tunnel connection completion notification (in S37). After that, the communication terminal 1 provides a communication request to the filter node 2 through the tunnel 5. The first network communication section 27 of the filter node 2 receives the communication request.

Then, the filter section 26 executes the filtering on the communication request. If communication is permitted, the communication terminal 1 communicates with a communication destination indicated by the communication request. If the communication is not permitted, the filter section 26 controls the communication so as not to permit the communication of the communication terminal 1.

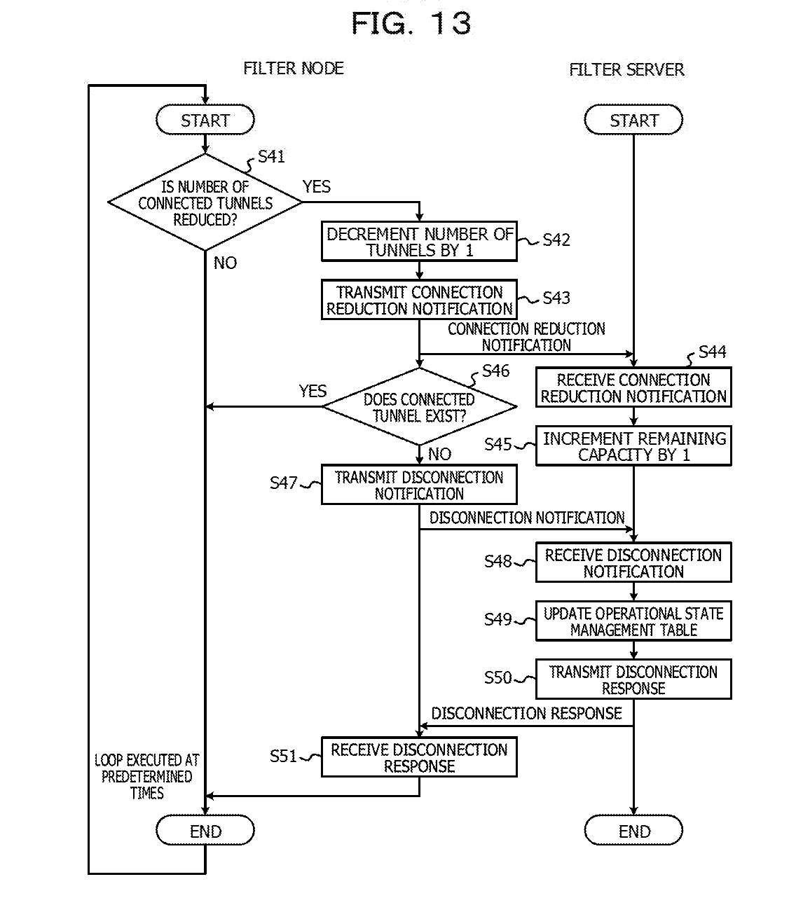

Next, an example of a process to be executed when the connection of the tunnel 5 is disconnected is described with reference to a sequence chart illustrated in FIG. 13. When the communication terminal 1 disconnects the connection to the filter node 2, the number of tunnels connected to the filter node 2 is reduced.

At each predetermined time, the filter node 2 determines whether or not the number of tunnels 5 connected to the filter node 2 is reduced (in S41). If the number of tunnels 5 connected to the filter node 2 is not reduced (No in S41), the process is terminated and the filter node 2 executes the process of S41 at each predetermined time.

If the number of tunnels 5 connected to the filter node 2 is reduced (Yes in S41), the tunnel number managing section 23 decrements the number of managed tunnels 5 connected to the filter node 2 by 1 (in S42). Then, the second network communication section 28 transmits, to the filter server 3, a notification (hereinafter referred to as connection reduction notification) indicating that the number of tunnels 5 connected to the filter node 2 was reduced (in S43).

The filter server 3 receives the connection reduction notification (in S44). Then, the operational state managing section 32 increments a remaining capacity, stored in the operational state management table, of the filter node 2 that transmitted the connection reduction notification (in S45).

The filter node 2 determines, based on the tunnel number managing section 23, whether or not a tunnel 5 connected to the filter node 2 exists (in S46). If the tunnel 5 connected to the filter node 2 exists (Yes in S46), the process is terminated and the filter node 2 executes the process of S41 after a predetermined time.

If the tunnel 5 connected to the filter node 2 does not exist (No in S46), the filter node 2 transmits, to the filter server 3, a disconnection notification indicating that the tunnel 5 connected to the filter node does not exist (in S47).

The filter server 3 receives the disconnection notification (in S48). The operational state managing section 32 updates, to the stopped in the operational state management table, the operational state of the filter node 2 that transmitted the disconnection notification (in S49).

The filter server 3 transmits, to the filter node 2 that transmitted the disconnection notification, a disconnection response indicating that the operational state management table was updated (in S50). The filter node 2 receives the disconnection response (in S51). Then, the process is terminated and the filter node 2 executes the process of S41 again after a predetermined time.

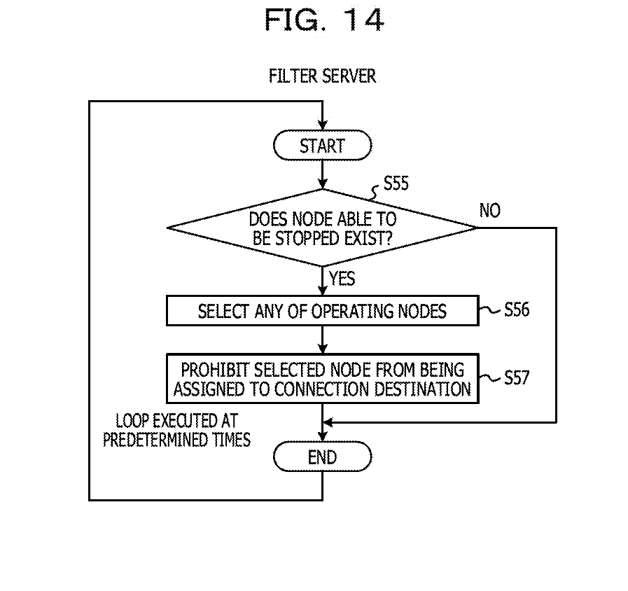

Next, an example of a process of stopping an operating filter node is described with reference to FIG. 14. The connection destination determining section 31 of the filter server 3 determines whether or not a filter node 2 that is among the filter nodes 2 and able to be stopped exists (in S55).

Whether or not each filter node 2 that is able to be stopped exists is determined based on the upper limit on the number of tunnels 5 able to be connected to the filter node 2 and a remaining capacity of the filter node 2 that is indicated in the operational state management table managed by the operational state managing section 32.

The connection destination determining section 31 acquires a remaining capacity of an operating filter node 2 from the operational state management table managed by the operational state managing section 32. If multiple filter nodes 2 that are operating exist, the connection destination determining section 31 adds up remaining capacities of the filter nodes 2 that are operating.

If the total of the remaining capacities exceeds the largest capacity among upper limits (capacities) of the operating filter nodes 2, the connection destination determining section 31 determines that a filter node 2 that is able to be stopped exists. On the other hand, if the total of the remaining capacities is equal to or smaller than the largest capacity, the connection destination determining section 31 determines that a filter node 2 that is able to be stopped does not exist.

In the embodiment, the capacities of the filter nodes 2 are 10. Thus, if the total of the remaining capacities exceeds 10, the connection destination determining section 31 determines that a filter node 2 that is able to be stopped exists.

For example, it is assumed that three filter nodes 2 are operating and the total of remaining capacities of the filter nodes 2 is 15. In this case, even if a single filter node 2 among the operating filter nodes 2 is to be stopped, tunnels 5 assigned to the filter node 2 to be stopped are able to be assigned to the other two filter nodes 2.

If the total of remaining capacities is 8 and a single filter node 2 is stopped, the other two filter nodes 2 able to be assigned are not sufficient based on the remaining capacities of the other two filter nodes 2.

According to the aforementioned standard, the connection destination determining section 31 determines whether or not a filter node 2 able to be stopped exists. If the filter node that is able to be stopped does not exist (No in S55), the filter server 3 does not stop the filter nodes that are operating.

If the filter node 2 that is able to be stopped exists (Yes in S55), the connection destination determining section 31 selects any of the filter nodes 2 that are operating (in S56). Then, when the filter server 3 receives the request to acquire the connection destination from the communication terminal 1, the connection destination determining section 31 does not assign the selected filter node 2 to the connection destination (in S57). Thus, the selected filter node 2 transitions to the stop pending state.

Since the filter server 3 does not newly assign the communication terminal 1 to the filter node 2, the connection between the filter node 2 and the communication terminal 1 connected to the filter node 2 is disconnected and the number of communication terminals 1 assigned to the filter node 2 is reduced over time. Then, when the number of communication terminals 1 connected to the filter node 2 becomes 0, the filter node 2 autonomously transitions to the stopped state. The filter server 3 executes the aforementioned processes at predetermined times.

When the number of operating filter nodes 2 is reduced, the operating rate M is reduced and peak traffic upon the distribution of the filter rules is reduced. In the aforementioned example, if the operating rate is M, the peak traffic upon the distribution of the filter rules is N×M and the peak traffic is reduced, compared with the case where all the filter nodes 2 are operating.

As described above, the filter server 3 controls the filter nodes 2 so as to cause a filter node 2 stopped for a long time to operate. Thus, the amount of data of the filter rules to be collectively distributed by the filter server 3 is reduced and the peak traffic is reduced.

Thus, the filter server 3 stops an operating filter node 2 and causes a filter node 2 stopped for a long time to operate, and the filter server 3 adjusts, to an appropriate number, the number of operating filter nodes to which filter rules are distributed. Thus, the peak traffic upon the distribution of the filter rules is reduced.

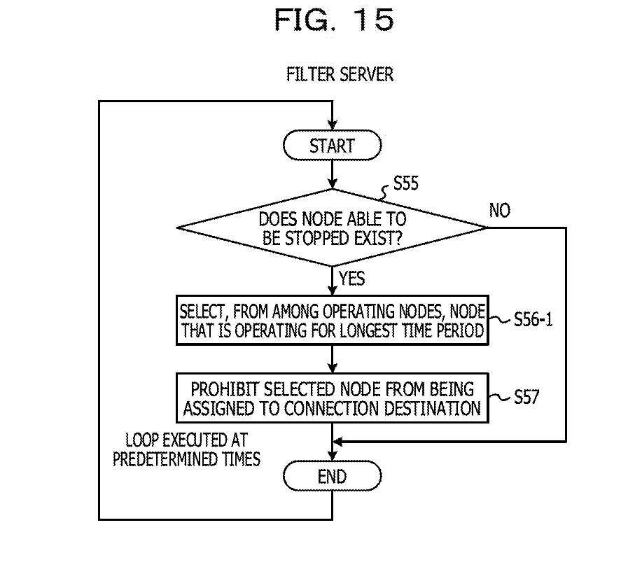

FIG. 15 illustrates another example of the process of stopping a filter node. In FIG. 15, the connection destination determining section 31 selects, from among the operating filter nodes 2, a filter node 2 that is operating for the longest time (in S56-1).

A time period that elapses after a filter node 2 that is operating for a short time period starts communicating with a communication terminal 1 is short, and a time period to the time when a connection between the filter node 2 and the communication terminal 1 is disconnected is long. On the other hand, a time period that elapses after a filter node 2 that is operating for a long time period starts communicating with a communication terminal 1 is long, and a time period to the time when a connection between the filter node 2 and the communication terminal 1 is disconnected is short.

During the time when the filter node 2 communicates with the communication terminal 1, the filter node 2 does not transition to the stopped state. When the connection between the filter node 2 and the communication terminal 1 is disconnected, the filter node 2 transitions to the stopped state. Thus, if a filter node 2 that is operating for the longest time period transitions to the stop pending state, a time for causing the filter node 2 to transition to the stopped state is the shortest, and thus an effect of reducing peak traffic upon the distribution of filter rules is the highest.

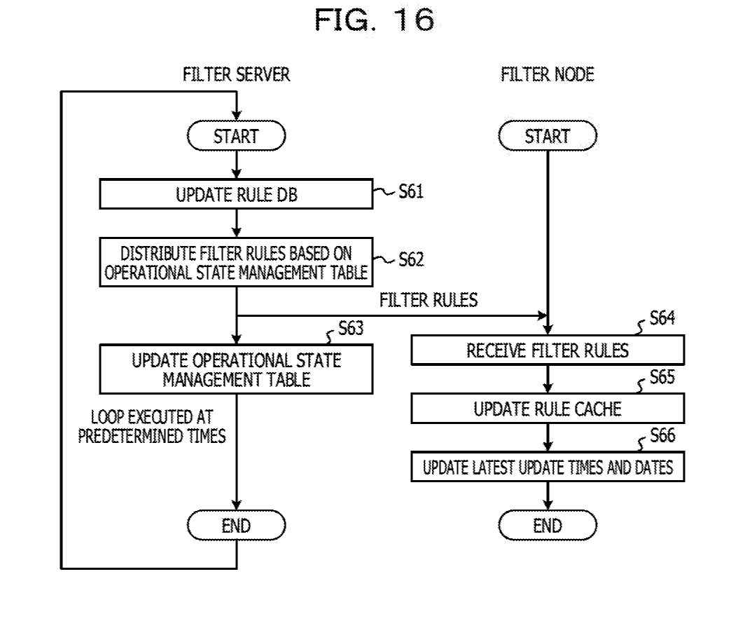

Next, an example of a process of updating the filter rules is described with reference to FIG. 16. When the filter rules are updated, the filter server 3 updates the filter rules of the rule database 35 (in S61). In this case, the filter server 3 also updates the latest times and dates when the filter rules are updated in the rule database 35.

The filter server 3 may acquire new filter rules using an arbitrary method. For example, the filter server 3 may acquire new filter rules from a server or the like that generated the filter rules, and the filter server 3 may update the filter rules of the rule database 35.

The distributor 33 distributes the filter rules to a filter node 2 whose operational state indicates operating in the operational state management table managed by the operational state managing section 32 (in S62). The distributor 33 collectively distributes, to a filter node 2 whose operational state indicates operation start pending, the filter rules that are yet to be received by the filter node 2. Then, the filter server 3 updates the latest update times and dates of the operational state management state managed by the operational state managing section 32 (in S63).

The filter node 2 receives the filter rules (in S64). The filter node 2 updates the filter rules of the rule cache 25 (in S65). The update time and date managing section 24 updates the latest times and dates when the filter rules are updated (in S66).

In this manner, the filter rules are updated. The aforementioned processes are executed every time the filter rules are updated.

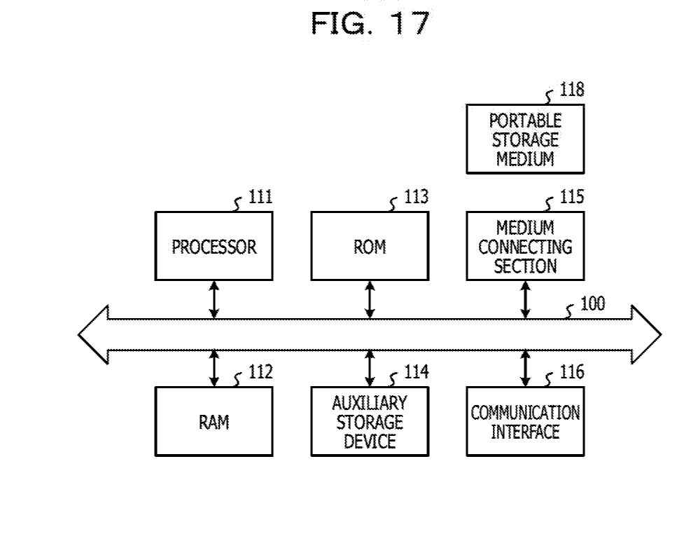

Next, an example of a hardware configuration of the filter server 3 is described with reference to FIG. 17. As illustrated in the example of FIG. 17, a processor 111, a RAM 112, a ROM 113, an auxiliary storage device 114, a medium connecting section 115, and a communication interface 116 are connected to a bus 100.

The processor 111 is an arbitrary processing circuit. The processor 111 executes a program loaded in the RAM 112. As the program to be executed, a program that enables the processes described in the embodiment to be executed may be applied. Specifically, the processor 111 executes the given distribution control program and thereby provides the functions of the connection destination determining section 31, operational state managing section 32, distributor 33, and traffic managing section 34 that are illustrated in FIG. 2. The ROM 113 is a nonvolatile storage device for storing the program to be loaded in the RAM 112.

The auxiliary storage device 114 stores information of various types. The auxiliary storage device 114 is, for example, a hard disk drive, a semiconductor memory, or the like. The medium connecting section 115 may be connected to a portable storage medium 118.

As the portable storage medium 118, a portable memory or an optical disc (for example, a compact disc (CD), a digital versatile disc (DVD), or the like) may be used. The program that enables the processes described in the embodiment to be executed may be stored in the portable storage medium 118.

The rule database 35 of the filter server 3 is achieved by the RAM 112 or the auxiliary storage device 114, for example. The functions of the filter server 3 that exclude the rule database 35 are achieved by causing the processor 111 to execute the program, for example.

The RAM 112, the ROM 113, the auxiliary storage device 114, and the portable storage medium 118 are examples of tangible computer-readable storage media. The tangible computer-readable storage media are not temporal media such as signal carrier waves.

The embodiment is not limited to the aforementioned configurations and processes and may include various configurations and embodiments without departing from the gist of the embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A distribution control method executed by a computer configured to manage a plurality of nodes that controls communication between a plurality of communication devices and a plurality of information processing devices, each of the plurality of nodes having a filter rule indicating whether each of the information processing devices is permitted as a communication destination and collectively receiving, from the computer, all filter rules updated by the computer during a stopped state when the each of the plurality of nodes transits from the stopped state to an operating state, the distribution control method comprising:
stopping at least one node among the plurality of nodes;
operating at least one node among the plurality of nodes and is in the stopped state for a time period exceeding a predetermined threshold; and
distributing the updated filter rules to the at least one operating node among the plurality of nodes, when the filter rules are updated.

2. The distribution control method according to claim 1, further comprising
assigning, when a request for communication with one of the plurality of information processing devices is received from one of the plurality of communication devices, the operating node as a relay node configured to couple the one of the plurality of information processing devices to the one of the plurality of communication devices.

3. The distribution control method according to claim 1,
wherein the stopping includes stopping a node that is among the plurality of nodes and operates for the longest time period, and
wherein the causing the node to operate includes causing a node that is among the plurality of nodes and is stopped for the longest time period to operate.

4. The distribution control method according to claim 1,
wherein the causing the node to operate includes causing the at least one stopped node to operate if the amount of data of the updated filter rules to be distributed by the computer exceeds a predetermined threshold.

5. The distribution control method according to claim 1,
wherein each of the plurality of nodes has a capacity indicating an upper limit on the number of communication devices to be coupled, and
wherein the stopping includes stopping any of operating nodes among the plurality of nodes if the total of communication devices able to be coupled to the operating nodes exceeds the largest capacity of a node among the operating nodes.

6. The distribution control method according to claim 1, further comprising
assigning, when a request for communication with one of the plurality of information processing devices is received from one of the communication devices and the amount of data of the updated filter rules to be distributed by the computer does not exceed a predetermined value, a node that is among the plurality of nodes and is operating for the shortest time period as a relay node configured to couple the one of the plurality of communication devices to the one of the plurality of information processing devices.

7. The distribution control method according to claim 1,
wherein the causing the node to operate includes causing the at least one stopped node to operate if the number of communication devices coupled to all operating nodes among the plurality of nodes reaches an upper limit.

8. The distribution control method according to claim 1,
wherein the distributing includes
distributing the updated filter rules to the operating node and a node transitioning from the operating state to the stopped state, and
suppressing the distribution of the filter rules to the stopped node and a node transitioning from the stopped state to the operating state.

9. A distribution control device configured to manage a plurality of nodes that controls communication between a plurality of communication devices and a plurality of information processing devices, each of the plurality of nodes having a filter rule indicating whether each of the information processing devices is permitted as a communication destination and collectively receiving, from the distribution control device, all filter rules updated by the distribution control device during a stopped state when the each of the plurality of nodes transits from stopped states to an operating state, the distribution control device comprising:
a memory; and
a processor coupled to the memory and configured to:
stop at least one node among the plurality of nodes;
operate at least one node that is among the plurality of nodes and is in the stopped state for a time period exceeding a predetermined threshold; and
distribute the updated filter rules to the at least one operating node among the plurality of nodes, when the filter rules are updated.

10. A non-transitory computer-readable storage medium storing a program that causes one or more processors included in a computer to execute a process, the computer being configured to manage a plurality of nodes that controls communication between a plurality of communication devices and a plurality of information processing devices, each of the plurality of nodes having a filter rule indicating whether each of the information processing devices is permitted as a communication destination and collectively receiving, from the computer, all filter rules updated by the computer during a stopped state when the each of the plurality of nodes transits from the stopped state to an operating state, the process comprising:
stopping at least one node among the plurality of nodes;
operating at least one node among the plurality of nodes and is in the stopped state for a time period exceeding a predetermined threshold; and
distributing the updated filter rules to the at least one operating node among the plurality of nodes, when the filter rules are updated.
